(19) United States
(12) Patent Application Publication
(10) Pub. No.: US 2020/0166450 A1
(43) Pub. Date: May 28, 2020

(54) Sensor Element and Use of Same

(71) Applicant: PreSens Precision Sensing GmbH, Regensburg (DE)

(72) Inventor: Daniel RIECHERS, Regensburg (DE)

(21) Appl. No.: 16/775,181

(22) Filed: Jan. 28, 2020

Related U.S. Application Data
(63) Continuation of application No. PCT/IB2018/054960, filed on Jul. 5, 2018.

(30) Foreign Application Priority Data
Aug. 9, 2017 (DE) 10 2017 118 060.5

(51) Int. Cl. G01N 21/03; G01N 21/11

(52) U.S. Cl. CPC G01N 21/0303; G01N 21/11; G01N 2021/115; G01N 2021/0357; G01N 2021/0385

(57) ABSTRACT

A sensor element has a channel into which a sensor substance can be fed from a reservoir of the sensor element. The sensor substance has an optical behaviour which depends on an analyte. The analyte passes from a sample through a membrane permeable to the analyte into the channel, which membrane forms a portion of a wall of the channel.

### RELATED APPLICATIONS

This Application is a Continuation application of International Application PCT/IB2018/054960, filed on Jul. 5, 2018, which in turn claims priority to German Patent Applications DE 10 2017 118 060.5, filed Aug. 9, 2017, both of which are incorporated herein by reference in their entirety.

### FIELD OF THE INVENTION

The invention relates to a sensor element and its use for the detection of an analyte in a sample. In particular, the invention relates to a sensor element with a sensor substance which exhibits an optical behaviour depending on the analyte.

### BACKGROUND OF THE INVENTION

It is sufficiently known to use a dependence of an optical behaviour of a sensor substance, e.g. a dye, on an analyte, i.e. a substance to be detected, in order to detect this analyte qualitatively or quantitatively in a sample. For this purpose, the sensor substance or a sensor element containing the sensor substance is brought into contact with the sample in such a way that the analyte can reach the sensor substance. The optical behaviour of the sensor substance is then evaluated. Suitable sensor substances, various configurations of sensor elements containing one or more sensor substances, as well as various methods for detecting and evaluating the optical behaviour of a sensor substance are known to the skilled person, see for example the German patent applications DE 10 2010 061 182 A1, DE 10 2011 055 272 A1, DE 10 2014 107 837 A1 or the German patent 10 2013 108 659 B3, as well as the documents of prior art cited therein.

Prior art sensor elements often require a certain amount of preparation by the user, and thus effort, before the sensor element can be used. For some sensor elements it is necessary to soak them in water for some time to make them ready for use. A system for monitoring blood parameter values is offered by the company Terumo as CDI System 500. This system includes a calibrator with two gases to calibrate sensors of the system prior to measurement. This can take about 20 minutes. The sensors are operated in a flow cell. It is also important to ensure that sensor elements are not stored for too long, as this could result in a loss of functionality. In particular, an initial calibration of the sensor element may become invalid, which makes it necessary to recalibrate the sensor element, usually immediately before it is used; however, this again means additional work before the actual measurement. Apart from the general disadvantage that the user has to carry out some preliminary work prior to the measurement itself, a delay before the measurement itself is particularly critical in some areas, for example in emergency and intensive care medicine.

It is also known to perform analyses with microfluidic arrangements. Some such arrangements have a sample chamber to which reagents are supplied via one or more channels, see for example publication WO 2015/150742 A1 of the international application PCT/GB2015/050905, or a sample is supplied via a sample inlet to a channel system which guides the sample to one or more chambers in which reagents are stored, see for example publication WO 2014/159834 A1 of the international application PCT/US2014/025281. The reagents are stored in reservoirs, which may be designed as blisters. Such devices are suitable for subjecting a sample taken to analysis. It is not possible, for example, to monitor the concentration of an analyte in a volume, such as a bioreactor, a cell culture, or generally of an analyte during a reaction process over a period of time.

### SUMMARY OF THE INVENTION

It therefore is the object of the invention to provide a sensor element which is ready for use quickly and versatile.

This object is achieved by a sensor element according to claim 1.

A corresponding use of the sensor element is the subject of claim 17.

The sensor element according to the invention contains a reservoir in which a sensor substance is contained. The sensor substance exhibits an optical behaviour that depends on an analyte. The optical behaviour may, for example, be a colour or a luminescence phenomenon; luminescence comprises at least fluorescence and phosphorescence. Depending on the analyte, i.e. for example depending on the concentration or partial pressure of the analyte, the optical behaviour may change. For example, the sensor substance may change its colour, which can be detected using colorimetric methods, for example. In the case of a luminescence phenomenon, for example, an intensity of the luminescence or a decay time of intensity or polarisation of the luminescence may depend on the concentration or partial pressure of the analyte. Also, a reflectivity of the sensor substance which depends on the analyte can be used for the detection of the analyte. Evaluation of the optical behaviour of the sensor substance thus enables qualitative or quantitative detection of the analyte. Thus, concentration or partial pressure of the analyte can be determined up to field-specific error limits, or it can be determined that concentration or partial pressure of the analyte are within a certain range, wherein this certain range is characterized by an upper limit and a lower limit or only by an upper limit or only by a lower limit.

The sensor element according to the invention further comprises a channel. The sensor element is configured such that the sensor substance can be fed from the reservoir into the channel. It is conceivable here that the reservoir contains only the sensor substance. It is also conceivable that the sensor substance in the reservoir is a component of a sensor composition which can be fed from the reservoir into the channel. When the sensor substance or sensor composition is fed into the channel, the reservoir can be completely or partially emptied.

According to the invention, the sensor element has a membrane which is permeable to the analyte and which forms a portion of a wall of the channel. Depending on the analyte and the environment in which the sensor element is to be used, suitable membranes are known to the skilled person. The membranes suitable for the sensor element according to the invention are also used in the prior art to form a selectively permeable layer between a sample and, for example, a layer containing a sensor substance in a sensor element.

With a sensor element according to the invention, sensor substance, for example as part of a sensor composition, can be fed into the channel for measurement. The analyte to be detected can pass through the membrane into the channel and thus come into contact with the sensor substance. By evaluating the optical behaviour of the sensor substance in the channel in contact with the analyte, the analyte can be detected qualitatively or quantitatively. Extensive preparatory work is not necessary. The membrane can be brought into contact with a sample volume, for example, without being restricted thereto, in a port of a bioreactor or in a flow element; the sensor element according to the invention is thus also suitable for measuring the analyte over a period of time.

Various shapes and cross-sections are conceivable for the channel. For example, without limiting the invention, the channel can be straight, meandering, zig-zag or spiral. The feeding of the sensor substance into the channel is preferably facilitated by capillary forces; further facilitation is possible if the channel and/or the channel-side surface of the membrane is hydrophilized.

In one embodiment, the channel is formed in a carrier plate and covered by the membrane. Here, the carrier plate is advantageously transparent for the wavelength ranges of light relevant for the detection of the analyte; if the optical behaviour of the analyte is a luminescence phenomenon, the carrier plate is for instance transparent for excitation light to excite the luminescence and for luminescence light. The membrane can be glued or welded to the carrier plate, for example. Another possibility is to clamp the membrane to the carrier plate; for this purpose, a metal grid or perforated plate can be used, for example, which is connected to the carrier plate at its edge by means of clamps and presses the membrane flat against the carrier plate without preventing the analyte from accessing the membrane. However, the invention is not limited to the mentioned possibilities of connection between membrane and carrier plate.

Alternatively, the membrane may form a tube, in which case the channel is formed by the interior of the tube. For reasons of handling and/or stability the tube is advantageously arranged on a carrier plate. What has been said above about the light transmission of the carrier plate also applies to this carrier plate.

In preferred further developments of each of the above-mentioned embodiments with carrier plate, the reservoir and any further components of the sensor element are also located on the carrier plate.

Possible materials for the carrier plate, without limiting the invention, for example are: cycloolefin copolymers (COC), polycarbonates, polystyrenes, glass, polyethylene terephthalate (PET), polymethyl methacrylate (PMMA), polyethylene naphthalate (PEN).

It is advantageous if the carrier plate, unlike the membrane, is not permeable to the analyte. The membrane can then be brought into contact with the sample; the sensor substance in the channel is then only affected by the analyte from the sample. If analyte is also present outside the sample in the environment in which the sensor element is used, for example carbon dioxide as analyte in the sample and in the ambient air, a carrier plate that is impermeable to the analyte prevents the sensor substance from being additionally affected by analyte that enters the channel through the carrier plate. Furthermore, a carrier plate that is impermeable to the analyte prevents the analyte from diffusing into the carrier plate and thus apparently reducing the analyte concentration or causing hysteresis effects due to the analyte then contained in the carrier plate.

In embodiments of the sensor element the reservoir is formed by a blister; preferably the blister is separated from the channel by a barrier. In one configuration, this barrier has a weakened portion at which it breaks open when the internal pressure in the blister increases, thus opening the way into the channel for the contents of the blister. In an alternative configuration, the sensor element has a device by which the barrier can be perforated to allow the contents of the blister to enter the channel. It is thus possible for a user to ready the sensor element for use by simply pressing on the blister. A barrier of the type just explained can also be used generally with a reservoir, i.e. even if the reservoir is not formed by a blister; this applies accordingly to a device for perforating the barrier.

The reservoir preferably seals its contents effectively against the environment as long as the barrier is intact. A diffusion of molecules out of or into the reservoir takes place only to a small extent at most. A sensor composition provided in the reservoir at the time of production of the sensor element thus changes its composition only moderately over time; in particular, diffusion of water out of the sensor composition is suppressed. Thus, the sensor composition over long periods of time is in a state which deviates only slightly from the state at an initial calibration of the sensor element. Thus, a recalibration of the sensor element prior to a measurement is usually unnecessary. If a blister is used as a reservoir, such an effective seal of the blister contents against the environment can be achieved by a metal layer, for example of aluminium. Such a blister typically loses less than 0.5% liquid from its contents over the course of a year when stored at room temperature.

In one embodiment, the sensor element has a plurality of reservoirs. Therein the sensor element is further configured such that a content of each of the plurality of reservoirs can be fed into the channel. For example, each of the reservoirs may contain the same sensor composition. Thus it is possible, for example, to fill the channel from one of the reservoirs with sensor composition at the beginning of a measurement and, when this filling of the channel has been used up, for example by “poisoning” of the sensor composition, to renew the filling of the channel from one of the other reservoirs. “Poisoning” of the sensor composition means the entry of substances other than the analyte into the sensor composition, which change the chemical conditions there so that these no longer correspond to the conditions at which the sensor was calibrated. For example, these substances may change the composition of a buffer, which in embodiments is a component of the sensor composition. Another possibility according to which the filling of a channel can be consumed is that a dye used as a sensor substance is gradually decomposed by exposure to light during measurements or exposure to ambient light. It may be advantageous to flush the channel prior to introducing fresh sensor composition. For this purpose, one of the reservoirs may contain a flushing liquid; a non-limiting example of a flushing liquid is distilled water.

In one embodiment, the sensor element contains a receptacle chamber into which the channel opens. Used sensor composition and flushing liquid can collect in the receptacle chamber. In this way, the sensor element's surroundings are not contaminated by the sensor composition or the flushing liquid, so the sensor element can be handled and used cleanly. In addition, the reservoir, channel and receptacle chamber together form a volume sealed off from the environment, which is advantageous for sterilizing the sensor. The boundaries of this volume, i.e. walls of reservoir, channel and receptacle chamber, form a sterile barrier, the sensor element can be sterilized by radiation. The receptacle chamber may be formed in particular by a blister.

In one embodiment, the sensor element has a first shutter device and a second shutter device. The first shutter device and the second shutter device allow a section of the channel extending between the first and second shutter device to be shut off. It is thus possible to fill the channel including said section from a reservoir with sensor composition and then to shut off the section so that a flow of sensor composition into or out of the section is prevented. Such flow could occur in particular due to a temperature gradient along the channel or due to a gradient of osmotic pressure through the membrane.

In one embodiment, the sensor element comprises a plurality of channels. For each of these channels, the above discussion may apply. In a further development, the sensor element has a reservoir in which a reference substance is contained. Here the sensor element is configured in such a way that the reference substance can be fed into a channel of the plurality of channels. The reference substance is a substance which shows an optical behaviour of preferably the same kind as the optical behaviour of the sensor substance, but the optical behaviour of the reference substance does not depend on the analyte. During a measurement, optical signals can then be detected simultaneously from a channel containing sensor substance and from a channel containing reference substance. In this way, effects such as fluctuations in the intensity of the excitation light or even cross-sensitivities can be taken into account.

In one embodiment, a first sensor substance from a first reservoir can be fed into a first channel of the plurality of channels, and a second sensor substance from a second reservoir can be fed into a second channel of the plurality of channels. First and second sensor substances may differ, for example, with respect to the analyte on which a respective optical behaviour of the first and second sensor substance depends. In this way, more than one analyte can be measured with the sensor element. The results can also be used again to take into account cross-sensitivities. It is also conceivable that the optical behaviour of the first sensor substance and the optical behaviour of the second sensor substance depend on the same analyte, but that this dependence only manifests in a way useful for a measurement in certain ranges of values of the concentration or the partial pressure of the analyte. If these ranges of values are different for the first and the second sensor substance, a larger range of values of the concentration or the partial pressure of the analyte can be covered with the sensor element. The sensor substances may also differ with regard to the type of optical behaviour.

Instead of introducing two different sensor substances into separate channels, as described above, in some embodiments it is intended to introduce these two different sensor substances into a common channel. For this purpose, the two sensor substances may already be stored mixed in one reservoir, or each sensor substance may be stored in a separate reservoir. In either case, the sensor substances can be fed from the reservoir(s) into the channel.

In embodiments, a reservoir contains a plurality of chambers. In each of the chambers, at least one component of a sensor composition is stored. In this embodiment the components are only mixed, i.e. the sensor composition is only formed, when the sensor composition is to be fed into a channel of the sensor element. This is advantageous if components of the sensor composition are unstable after prolonged contact of the components, so that a longer storage of the components as a mixture is not possible. In such a case it can be particularly advantageous to provide several similar reservoirs on the sensor element in order to be able to renew the sensor composition in the channel if necessary, as explained above in a more general context.

In a special configuration, the sensor element serves to detect carbon dioxide, which is thus analyte within the meaning of the application. The membrane is gas-permeable and ion-impermeable, for example a microporous membrane made of polyethylene (PE), polypropylene (PP), e.g. Accurel PP, polytetrafluoroethylene (PTFE), polyvinylidene fluoride (PVDF), or e.g. a monolithic film of PVDF, PTFE, silicone, PE, perfluoroalkoxylalkane (PFA). The reservoir contains an alkaline sensor composition with HPTS as dye, HEPES buffer, carbonic anhydrase and the necessary amount of common salt to adjust the sensor solution to the osmotic pressure of the sample containing the analyte. The carbon dioxide is detected indirectly via the change in the pH value of the sensor composition caused by the carbon dioxide; the luminescence behaviour of HPTS depends on the pH value.

In this example, the membrane/film can be hydrophilized on the side facing the channel, e.g. by plasma etching or plasma grafting of hydrophilic monomers (e.g. allyl alcohol), so that filling of the channel by capillary forces is possible without bubbles.

With a sensor element according to the invention, depending on the sensor substance or sensor composition used, other analytes can also be detected, for example the partial pressure of gases such as oxygen, sulphur dioxide or ammonia, the concentration of ions or molecules, or the pH value can be measured. Corresponding suitable sensor substances or sensor compositions are known to the skilled person.

A sensor element according to the invention of the type described above is generally used for the detection of an analyte in a sample in such a way that the membrane is brought into contact with the sample and the sensor composition is fed into the channel, wherein the sequence of these two steps is usually irrelevant unless determined by circumstances such as the measurement setup. Light is then directed onto the channel, for example to excite luminescence or to be able to determine a colour or reflectivity, and optical signals from the channel are recorded. The recorded signals are evaluated for qualitative or quantitative detection of the analyte. Excitation, recording and evaluation are performed according to one of the methods known from prior art.

### BRIEF DESCRIPTION OF THE DRAWINGS

Below, the invention and its advantages are explained in more detail with reference to the attached drawings.

FIG. 1 shows a top view of a sensor element according to the invention.

FIG. 2 shows a sectional view of the sensor element according to the invention from FIG. 1.

FIG. 3 shows a top view of a further sensor element according to the invention.

FIG. 4 shows a top view of a further sensor element according to the invention.

FIG. 5 shows a sectional view of a sensor element according to the invention.

FIG. 6 shows a sectional view of a reservoir.

FIG. 7 shows a sensor element according to the invention in a measuring arrangement.

FIG. 8 shows a sensor element according to the invention in a further measuring arrangement.

### DETAILED DESCRIPTION OF THE PREFERRED EMBODIMENTS

The figures only show examples of the invention in a schematic manner, without limiting the invention to the examples shown. It should also be noted that, for reasons of clarity of presentation to illustrate the invention, the elements shown in the drawings are not necessarily to scale.

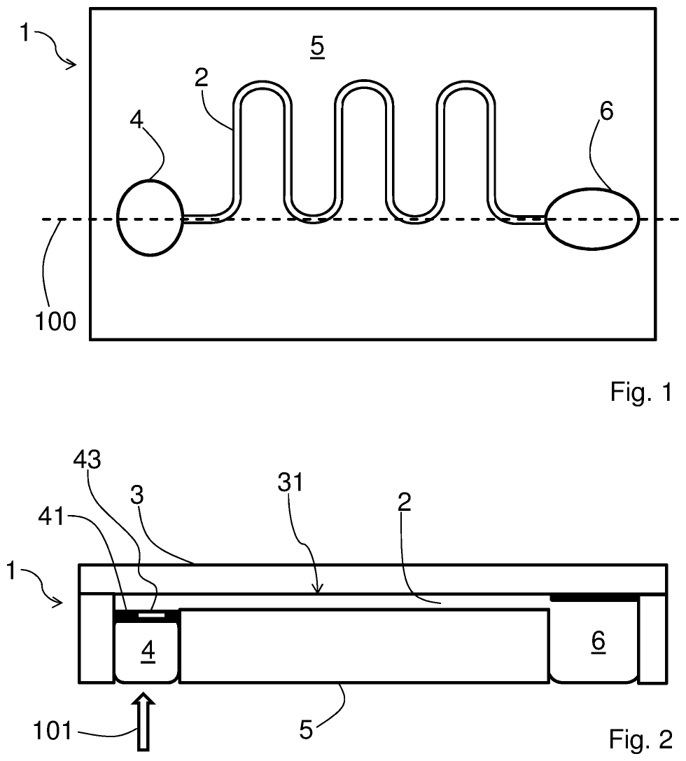

FIG. 1 shows a top view of a sensor element 1 according to the invention, wherein membrane 3 (see FIG. 2) is not shown. In the embodiment shown, the channel 2 runs in meanders and is formed in a carrier plate 5. A sensor substance can be fed into channel 2 from a reservoir 4. This is done in preparation for a measurement. Previously, as long as the sensor element 1 for instance is stored and only kept available for use, the sensor substance is enclosed in the reservoir 4, sometimes as a component of a sensor composition. The embodiment of the sensor element 1 shown further has a receptacle chamber 6.

Compared with a channel running straight between reservoir 4 and receptacle chamber 6, the meandering channel 2 used in the embodiment shown has the advantage that a larger amount of sensor composition and thus a larger amount of sensor substance can be provided in channel 2. Thus, excitation light can be used more efficiently and e.g. a more intense luminescence signal of the sensor substance can be received from channel 2. Thus, a given relative change in luminescence intensity is also greater in absolute terms, which improves the accuracy of the measurement. Nevertheless, the invention can also be realized with a linear channel.

FIG. 2 shows a sectional view of the sensor element 1 of FIG. 1 according to the invention along line 100 shown in FIG. 1. The shape of channel 2 is shown in simplified form. The carrier plate 5 is covered by membrane 3. The membrane 3 also covers channel 2 and thus forms a portion of a wall of channel 2.

Barrier 41 is also shown, through which reservoir 4 is sealed against channel 2. In the state shown, there is thus no sensor substance in channel 2. The reservoir 4 may, for example, be formed by a blister. If a sufficiently large force is exerted on the reservoir or blister 4, respectively, in the direction of the arrow 101, a weakened portion 43 of barrier 41 opens and the contents of the reservoir can enter channel 2. In embodiments, channel 2 has a rectangular cross section of e.g. 100 μm by 100 μm size, without, however, limiting the invention to this. With such dimensions, the filling of channel 2 with sensor composition from reservoir 4 is facilitated by capillary forces. If channel 2 and a surface 31 of membrane 3 facing channel 2 are hydrophilized, the filling of channel 2 is additionally facilitated. The force on the reservoir 4 in the direction of the arrow 101 may be applied directly by a user, for example by pressing with a finger, or, for example, by a plunger or other element of a higher-level apparatus into which the sensor element 1 is inserted. This is irrelevant to the principle of the invention. Likewise, the exact design of the barrier, of the weakened portion 43 or of a perforation mechanism for the barrier are not relevant to the invention; corresponding details can be taken from the prior art if necessary.

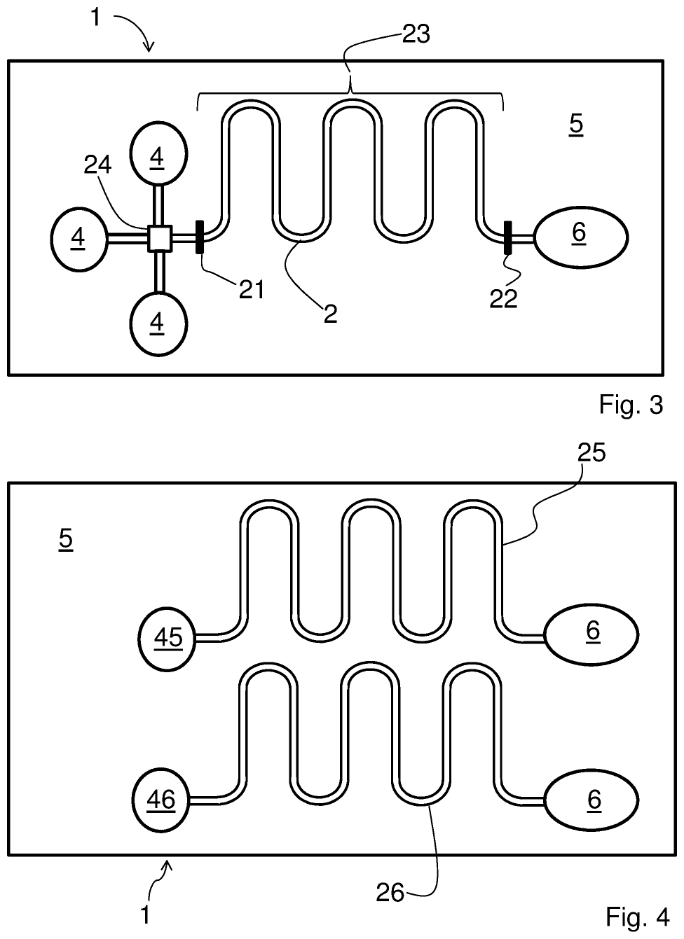

FIG. 3 shows, corresponding to the illustration in FIG. 1, a further version of a sensor element 1 according to the invention. In sensor element 1, channel 2 is formed in a carrier plate 5. The channel 2 opens into a receptacle chamber 6. In the embodiment shown the sensor element 1 has a plurality of reservoirs 4, here in particular three reservoirs 4. For example, each of the reservoirs 4 may contain the same sensor composition, channel 2 is then filled with sensor composition from one of the reservoirs 4, and sensor element 1 is used for measurements. If necessary, the sensor composition in channel 2 can then be renewed from one of the other reservoirs 4. Also, one of the reservoirs 4 may contain flushing liquid for channel 2. In order to avoid a flow of sensor composition or flushing liquid from a reservoir 4 into a previously emptied reservoir 4, valves may be provided, e.g. in junction area 24. A first shutter device 21 and a second shutter device 22 are provided for channel 2 in the embodiment shown. A section 23 of channel 2 between the first shutter device 21 and the second shutter device 22 can be shut off by the shutter devices 21, 22. This may be done, for example, after filling channel 2 with sensor composition in order to avoid a flow of the sensor composition through channel 2 and especially through the meandering section 23 during a measurement; such a flow may be caused, for example, by a temperature gradient along the channel and cause a drift of an optical signal from channel 2.

FIG. 4 shows, corresponding to the illustration in FIG. 1, a further embodiment of a sensor element 1 according to the invention. The sensor element 1 has, in carrier plate 5, a first channel 25 and a second channel 26, each of which opens into a separate receptacle chamber 6. It is also conceivable that both channels 25 and 26 open into a common receptacle chamber. In one configuration, a first sensor substance can be fed into the first channel 25 from a first reservoir 45, for example as a component of a sensor composition. In this configuration, a second sensor substance, for example as a component of a sensor composition, can be fed into the second channel 26 from a second reservoir 46. The first and the second sensor substance may differ, for example, with respect to the analyte on which their respective optical behaviour depends. For example, the first sensor substance in the first channel 25 may emit luminescence light after excitation, the decay time of this luminescence depending on the partial pressure of oxygen; the second sensor substance in the second channel 26 may emit luminescence light after excitation, the decay time of this luminescence depending on the partial pressure of carbon dioxide. It is also possible that for both sensor substances the respective optical behaviour depends on the same analyte, for example on oxygen, but that the ranges of values of the concentration of the analyte differ in which a dependence of the optical behaviour of the respective sensor substance on the analyte is shown which is sufficient for a measurement. It is also possible that first and second sensor substances differ in the nature of their respective optical behaviour, for example, the colour of the first sensor substance may change in dependence on the concentration of an analyte, and the second sensor substance may exhibit a luminescence phenomenon, the decay time of which depends on the concentration of this analyte or of a different analyte.

In this way, two different analytes can be measured in one sample with the shown sensor element 1, or a larger range of the concentration or partial pressure of an analyte can be covered with sensor element 1.

In a different embodiment of the sensor element 1 shown, for example, a sensor substance can be fed into the first channel 25 from the first reservoir 45, for example as a component of a sensor composition. A reference substance, for example as a component of a reference composition, can be fed into the second channel 26 from the second reservoir 46. In this way, measurements of an analyte can be carried out with sensor element 1 using an optical behaviour of the sensor substance, wherein, for example, an optical behaviour of the reference substance is used for calibration purposes.

Also in the case of a sensor element 1 with several channels, for example as in FIG. 4 with two channels, several reservoirs can be provided for one or more of the channels, as shown in FIG. 3 for a channel 2.

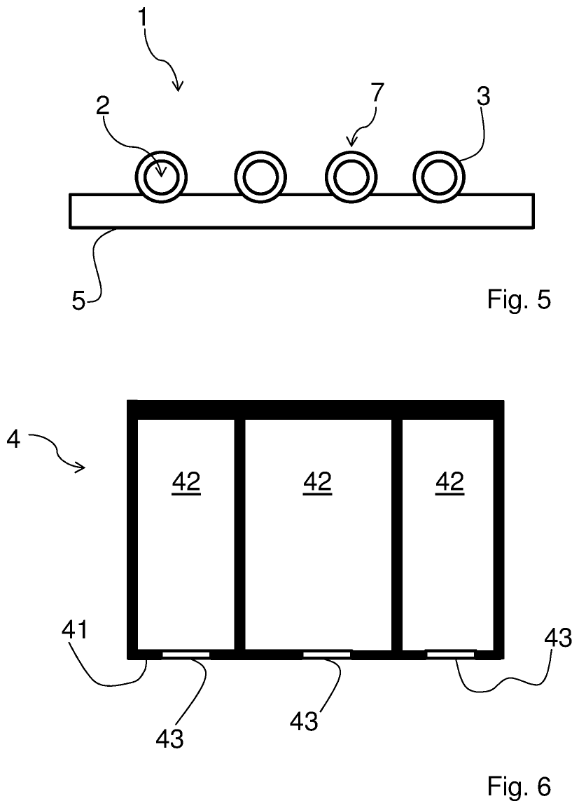

FIG. 5 shows a cross section of another embodiment of a sensor element 1 according to the invention. In this embodiment the channel 2 is a tube 7, which is formed by the membrane 3. This means that a tube 7 or a hose is formed from the membrane 3, the interior of which tube or hose is the channel 2. The membrane 3 forms the wall of the tube 7 and thus of the channel 2. In the embodiment shown, the tube 7 is attached to a carrier plate 5, e.g. glued to the carrier plate 5, where it runs in meanders so that the tube 7 is captured several times by the section shown.

FIG. 6 shows a cross-section of an embodiment of a reservoir 4. The reservoir 4 shown has three chambers 42, in which components of a sensor composition can be stored separated from each other. Reservoir 4 is closed by a barrier 41. Barrier 41 has a weakened portion 43 for each chamber 42. When used in a sensor element 1, as shown and explained in FIG. 2 for the reservoir 4 shown there, the weakened portions 43 can be made to burst by exerting a force on the reservoir 4 so that the contents of the three chambers 42 enter the channel 2 and are mixed.

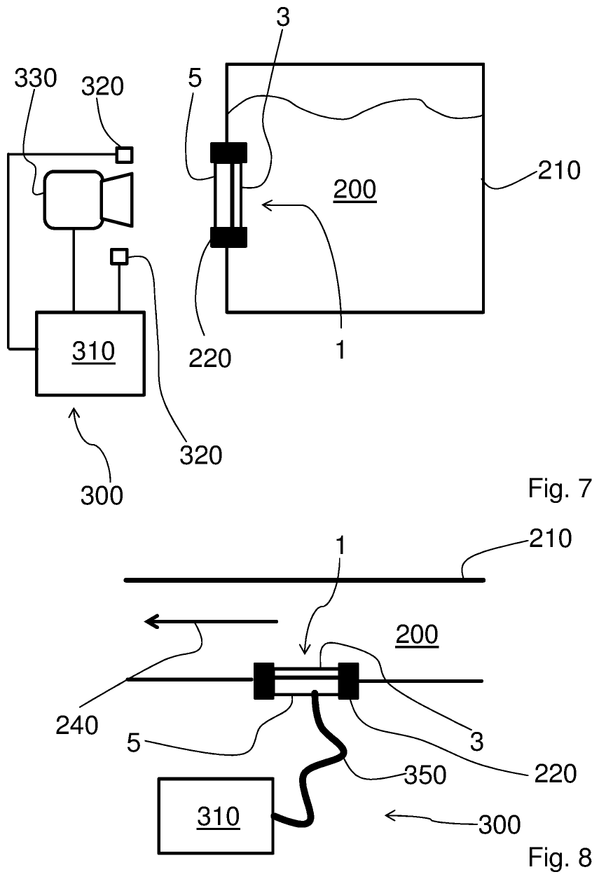

FIG. 7 shows a possible measuring arrangement 300, together with which the sensor element 1 according to the invention can be used to detect at least one analyte qualitatively or quantitatively in a sample 200. The sample 200 here is contained in a sample container 210; the sample container 210 may, for example, be a bioreactor, without limiting the invention to this. The sensor element 1 is mounted in a corresponding holder 220, for example a port of a bioreactor. Of sensor element 1, only membrane 3 and carrier plate 5 are shown. The membrane 3 is in contact with the sample 200, so that the at least one analyte can pass from the sample 200 through the membrane 3 to the channel or, depending on the configuration of sensor element 1, the channels of sensor element 1.

The measuring arrangement 300 here comprises a control unit 310, light sources 320 and a camera 330. The light sources 320 are intended to excite a luminescence of a sensor substance in a channel of sensor element 1, the camera 330 is intended to detect the luminescence signal from the sensor substance. Light sources 320 and camera 330 are controlled by the control unit 310. The evaluation, i.e. the determination of e.g. the concentration of the analyte, may also be carried out by the control unit 310.

In the embodiment shown, the carrier plate 5 is transparent to light from the light sources 320 for exciting the luminescence, and to the luminescence light. The membrane 3 can be configured such that it scatters light back to make better use of the excitation light and to direct a larger portion of the luminescence light towards the camera; to this end the membrane 3 may for example contain titanium dioxide particles. Additional optical elements, including filters, may be provided between light sources 320 and carrier plate 5 and/or between carrier plate 5 and camera 330. The sample container 210 may contain further elements, such as an agitator. Instead of the camera 330, other detector devices may be used. Instead of the free-beam optics shown here, excitation light and/or luminescence light may also be guided via waveguides, in particular optical fibres.

FIG. 8 shows a further possible measuring arrangement 300, with which the sensor element 1 according to the invention can be used to detect at least one analyte in a sample 200 qualitatively or quantitatively. The sample 200 is in a sample container 210, which is designed as a flow element, and here the sample 200 flows through the flow element in the flow direction 240. Sensor element 1, of which only membrane 3 and carrier plate 5 are shown, is located in a holder 220, which is provided in the wall of the flow element. The membrane 3 therein is in contact with the sample 200, so that the at least one analyte from the sample 200 can pass through the membrane 3 to the channel or, depending on the configuration of the sensor element 1, the channels of the sensor element 1. The measuring arrangement 300 here comprises a control unit 310 and an optical fibre 350, shown only very schematically. Suitable coupling devices for optical fibres to sensor elements are known to the person skilled in the art. The optical fibre 350 serves to guide light from a light source (not shown) provided in the control unit 310 to the sensor element 1 in order to there excite a luminescence of a sensor substance in a channel of the sensor element 1. Likewise, luminescence light generated in this way is guided from the sensor substance through the optical fibre 350 to the control unit 310 in order to there be, after detection by a detector (not shown) provided in the control unit 310, evaluated for the detection of the analyte. Instead of the optical fibre 350, free-beam optics, for example as shown in FIG. 7, could also be used here. Here too, as in the embodiment of FIG. 7, the membrane 3 may be configured to scatter back light. As in the embodiment of FIG. 7, the carrier plate 5 is transparent to light for exciting the luminescence of the sensor substance and to luminescence light from the sensor substance.

### LIST OF REFERENCE SIGNS

1 sensor element
2 channel
3 membrane
4 reservoir
5 carrier plate
6 receptacle chamber
7 tube
21 first shutter device
22 second shutter device
23 section of the channel
24 junction area
25 first channel
26 second channel
31 surface of the membrane
41 barrier
42 chamber
43 weakened portion
45 first reservoir
46 second reservoir
100 line
101 arrow
200 sample
210 sample container
220 holder for sensor element
240 flow direction
300 measuring arrangement
310 control unit
320 light source
330 camera
350 optical fibre

What is claimed is:

1. A sensor element comprising:
a reservoir comprising a sensor substance having an optical behaviour depending on an analyte;
a channel, wherein the sensor element is configured such that the sensor substance can be fed from the reservoir into the channel; and
a membrane which is permeable to the analyte and which forms a portion of a wall of the channel.

2. The sensor element according to claim 1, wherein the channel is formed in a carrier plate and covered by the membrane.

3. The sensor element according to claim 1, wherein the channel is formed by an inner region of a tube formed by the membrane.

4. The sensor element according to claim 3, wherein the tube is arranged on a carrier plate.

5. The sensor element according to claim 1, wherein the reservoir is formed by a blister.

6. The sensor element according to claim 1, wherein the reservoir is separated from the channel by a barrier, wherein the barrier has a weakened portion, or wherein the sensor element comprises a device by which the barrier can be perforated.

7. The sensor element according to claim 1, wherein the sensor element has a plurality of reservoirs, and the sensor element is configured such that a content of each reservoir of the plurality of reservoirs can be fed into the channel.

8. The sensor element according to claim 7, wherein one reservoir of the plurality of reservoirs comprises a flushing liquid.

9. The sensor element according to claim 1, wherein the sensor element comprises a receptacle chamber into which the channel opens.

10. The sensor element according to claim 9, wherein the receptacle chamber is formed by a blister.

11. The sensor element according to claim 1, further comprising a first shutter device and a second shutter device, wherein a section of the channel extending between the first shutter device and the second shutter device can be shut off by the first shutter device and the second shutter device.

12. The sensor element according to claim 1, wherein the sensor element comprises a plurality of channels.

13. The sensor element according to claim 12, further comprising a reservoir in which a reference substance is contained, wherein the sensor element is configured such that the reference substance can be fed into another channel of the plurality of channels.

14. The sensor element according to claim 12, wherein a first sensor substance from a first reservoir can be fed into a first channel of the plurality of channels, a second sensor substance from a second reservoir can be fed into a second channel of the plurality of channels, and wherein the first sensor substance and the second sensor substance differ with respect to the analyte on which a respective optical behaviour of the respective sensor substance depends, and/or with respect to a range of values of the analyte for which a dependence of the respective optical behaviour of the respective sensor substance on the analyte manifests itself, and/or with respect to a type of the optical behaviour.

15. The sensor element according to claim 1, wherein at least two sensor substances are provided to be fed into a channel of the sensor element and wherein the sensor substances differ with respect to the analyte on which a respective optical behaviour of the respective sensor substance depends, and/or with respect to a range of values of the analyte for which a dependence of the respective optical behaviour of the respective sensor substance manifests itself, and/or with respect to a type of optical behaviour.

16. The sensor element according to claim 1, wherein a reservoir comprises a plurality of chambers and at least one component of a sensor composition is stored in each of the chambers.

17. A method of using a sensor element for detecting an analyte in a sample, the method comprising:
providing a sensor element comprising:
a reservoir containing a sensor substance having an optical behaviour depending on an analyte;
a channel, wherein the sensor element is configured such that the sensor substance can be fed from the reservoir into the channel; and
a membrane which is permeable to the analyte and which forms a portion of a wall of the channel;
bringing the membrane into contact with the sample;
feeding the sensor composition into the channel;
directing light onto the channel; and
recording optical signals from the channel and evaluating recorded optical signals for qualitative or quantitative detection of the analyte.
